(19) United States
(12) Patent Application Publication
(10) Pub. No.: US 2018/0172824 A1
(43) Pub. Date: Jun. 21, 2018

(54) SYSTEMS AND METHODS FOR ENHANCING SYNTHETIC APERTURE RADAR IMAGERY

(71) Applicants: Urthecast Corp, Vancouver (CA); King Abdulaziz City of Science and Technology, Riyadh (SA)

(72) Inventors: Keith Dennis Richard Beckett, New Westminster (CA); George Tyc, Tsawwassen (CA)

(21) Appl. No.: 15/737,044

(22) PCT Filed: Jun. 15, 2016
(86) PCT No.: PCT/US2016/037681

§ 371 Date: Dec. 15, 2017

Related U.S. Application Data
(60) Provisional application No. 62/180,449, filed on Jun. 16, 2015.

(51) Int. Cl. G01S 13/90; G06T 1/20; G01S 13/86; G06K 9/62; B64G 1/10

(52) U.S. Cl. CPC G01S 13/9035; G06T 1/20; B64G 2001/1035; G06K 9/6267; B64G 1/1021; G01S 13/867

(57) ABSTRACT

An image processing system generates enhanced synthetic aperture radar (SAR) imagery using a trainer that generates an information model that defines a set of trained data based on correlated classifications of pairs of spatially and/or temporally coincident SAR and optical images, and using a SAR image enhancer that applies a transformation to generate a color image from the SAR image data. Correlated classifications may be based on specific applications. The system may generate or update trained data to be used for classification based on a set of training SAR images and training optical images. The system may assess or determine correlations between the classified SAR and optical image data sets, establishing levels of confidence in such correlations.

### TECHNICAL FIELD

The present disclosure relates generally to systems and methods for enhancing remotely sensed imagery, and, more particularly, to systems and application-specific methods for enhancing and interpreting synthetic aperture radar (SAR) imagery from space.

### BACKGROUND

### Description of the Related Art

Remote sensing refers generally to the collection of data at a distance. More specifically, the term is often used to refer to the sensing of electromagnetic radiation from an area or a target of interest. Orbital remote sensing (or remote sensing from space) includes the acquisition of images of the Earth's surface using a variety of sensors including synthetic aperture radar (SAR), cameras operating at visible and near infra-red (NIR) wavelengths, and high resolution video.

SAR images are high resolution images obtained using an active radar operating at microwave frequencies, typically in the range of approximately 0.1 GHz to 10 GHz. Raw SAR data can be acquired by a SAR sensor on a satellite and is usually downlinked to the ground for processing. In other instances, SAR data can be processed on-board the satellite and the images downlinked to the ground.

SAR data can be single-band or multi-band. An example of a dual-band SAR is an X-band and L-band SAR. A SAR sensor can be a polarimetric SAR capable of transmitting and/or receiving multiple polarizations such as horizontal and vertical linear polarizations.

Optical imagery generally refers to imagery acquired through passive observation at visible and/or NIR wavelengths. Optical sensors can include push broom sensors and high-resolution video cameras. Optical data can be multi-spectral and/or panchromatic.

SAR data and optical data can contain complementary information. Various data fusion methods have been proposed for combining SAR data and optical data to generate enhanced image products.

There are a number of techniques for classifying remotely sensed imagery such as SAR and optical imagery. Classification consists of establishing a number of categories of interest, and then analyzing properties of the image data to identify, within a certain tolerance, to which category a given pixel in the image belongs. The categorization is usually based on a training set. Supervised classification involves a training set of correctly identified observations. Unsupervised classification is based on clustering i.e., on a measurement of inherent similarity between observations.

Raw and classified remotely sensed imagery can be visually represented using a color scheme, where the color scheme is selected for ease of human or machine interpretation and is generally proportional to the signal level or information content related to the scene composition within each pixel location in the image.

### BRIEF SUMMARY

An image processing system may generate an enhanced synthetic aperture radar (SAR) image by generating an information model determined from SAR and optical image data, and applying the information model to an input SAR image. The information model can comprise trained data including associated metadata. A constellation of satellites may operate in pairs of satellites, the satellites of each pair which fly in a tandem configuration (one satellite leading, the other satellite trailing) and closely spaced around the orbit (for example, with a separation in time of approximately 60 seconds). Each pair of satellites can image the same target of interest with substantially the same geometry and at substantially the same time. In some implementations, a satellite may carry both SAR and optical sensors. In some implementations, one satellite of each pair can be dedicated to acquiring SAR data, and the other dedicated to acquiring optical imagery. The systems and methods described herein can be used with SAR and/or optical data acquired from satellites flying in a tandem configuration such as the tandem configuration described above. The systems and methods described herein can be used with SAR and/or optical data acquired from satellites flying in another suitable orbit configuration.

A method of operation of a synthetic aperture radar (SAR) image processing system may be summarized as including (a) gathering a set of raw training data, the gathering including receiving a training SAR image and a training optical image; determining one or more classifiers for a selected application; applying the one or more classifiers to the training SAR image and the training optical image to generate one or more classifications; determining one or more correlations between the one or more classifications; extracting classification model parameters based on the one or more correlations; and storing a set of raw training data including the classification model parameters in a first data set; (b) generating an information model including a set of information model parameters, the information model defining a set of trained data, the generating an information model including retrieving the set of raw training data from the first database; multiplexing the set of raw training data to generate the information model; and storing the information model parameters in a second data set; and (c) processing an input SAR image, the processing including receiving the input SAR image; extracting at least a subset of the information model parameters from the second data set; applying one or more SAR classifiers to the input SAR image to generate one or more SAR classifications; and applying the information model to the one or more SAR classifications to generate an enhanced SAR image.

The method may further include applying a color palette to the enhanced SAR image, wherein the color palette conveys information for the selected application based at least in part on the information model. Receiving a training SAR image and a training optical image may include receiving a training SAR image and a training optical image that are geographically coincident. Receiving a training SAR image and a training optical image may include receiving a training SAR image and a training optical image that are temporally coincident or near-coincident. Receiving a training SAR image and a training optical image may include receiving a training SAR image and a training optical image that are geographically coincident, and receiving a training SAR image and a training optical image that are temporally coincident or near-coincident. Two or more of the gathering a set of raw training data, the generating an information model, and the processing an input SAR image may be performed concurrently. Determining one or more classifiers for a selected application may include determining a first classifier for the training SAR image and determining a second classifier for the training optical image, and applying the one or more classifiers to the training SAR image and the training optical image to generate one or more classifications may include applying the first classifier to the training SAR image and applying the second classifier to the training optical image. The gathering, and/or the generating, may be repeated iteratively for a plurality of instances, and in each iteration, adjusting one or more parameters and dropping one or more of the SAR classifications based on a level of statistical correlation with the optical classifications, or for which the statistical confidence in the expected spread of variance in the optical classifications is not within a defined confidence interval.

The method may further include confirming that any remaining classifications have a moderate to a strong relationship based on a respective kappa coefficient value with the optical classifications; and in response to confirmation, stopping the iteration.

A synthetic aperture radar (SAR) image processing system may be summarized as including at least one nontransitory computer-readable medium that stores processor-executable instructions and data, the at least one nontransitory computer-readable medium which stores: a first data set of raw training data including classification model parameters based at least in part on a training SAR image and a training optical image, and that stores a second data set of trained data including an information model defined by information model parameters; a set of data gathering instructions which, when executed by at least one processor, cause the at least one processor to i) receive the training SAR image and the training optical image; ii) determine one or more classifiers for a selected application; and iii) apply the one or more classifiers to the training SAR image and the training optical image to generate the classification model parameters, the data gathering module communicatively coupled to the first data set to store the classification model parameters therein; a set of training instructions which, when executed by at least one processor, cause the at least one processor to receive the classification model parameters from the first data set, generate trained data including an information model, and store the information model parameters to the second data set; and a set of SAR image enhancer instructions which, when executed by at least one processor, cause the at least one processor to receive SAR image data from a source of SAR image data, classify the SAR image data, and apply the information model to generate an enhanced SAR image product.

The SAR image processing system may further include a set of display instructions which, when executed by the at least one processor, cause the at least one processor to manifest the enhanced SAR image product as a coloring of the SAR image wherein the coloring comprises a color palette that conveys information for the selected application based at least in part on the information model. The training SAR image and the training optical image may be geographically coincident. The training SAR image and the training optical image may be temporally coincident or near-coincident. The training SAR image and the training optical image may be geographically coincident, and the training SAR image and the training optical image may be temporally coincident or near-coincident. The set of data gathering instructions, the set of training instructions, and the set of SAR image enhancer instructions may operate concurrently. The set of data gathering instructions, the set of training instructions, and the set of SAR image enhancer instructions may operate concurrently on respective processors. The set of data gathering instructions, the set of training instructions, and the set of SAR image enhancer instructions may operate concurrently on respective cores of a single processor. The one or more classifiers for the selected application may include a first classifier for the training SAR image and a second classifier for the training optical image. The at least one processor may iteratively execute the set of data gathering instructions, and/or the set of training instructions for a plurality of instances, and in each iteration, may adjust one or more parameters and drops one or more of the SAR classifications based on a level of statistical correlation with the optical classifications or for which the statistical confidence in the expected spread of variance in the optical classifications is not within a defined confidence interval.

The SAR image processing system, when executed, may cause at least one processor further to confirm that any remaining classifications have a moderate to a strong relationship based on a respective kappa coefficient value with the optical classifications; and in response to confirmation, stop the iteration.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a block diagram illustrating an embodiment of a remote sensing system.

FIG. 2 is a block diagram illustrating an embodiment of a data processing system.

FIGS. 3A, 3B, 3C, and 3D are control flow charts illustrating a method for enhancing SAR imagery.

FIGS. 4A, 4B and 4C are data flow block diagrams illustrating the application-specific transformation of data for enhancing SAR imagery according to aspects of the method of FIG. 3.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure provided herein is for convenience only and does not interpret the scope or meaning of the embodiments.

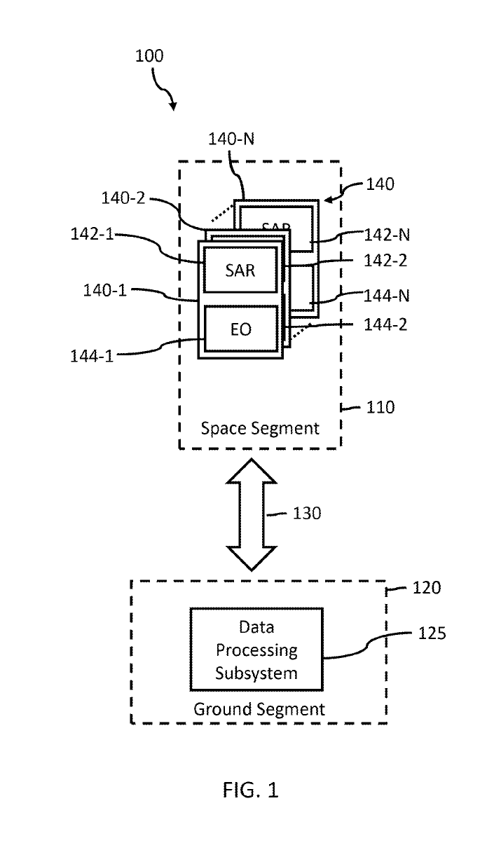

FIG. 1 shows a remote sensing system 100 according to at least one illustrated embodiment. Remote sensing system 100 comprises space segment 110 and ground segment 120. Space segment 110 is communicatively coupled to ground segment 120 via interface 130. Interface 130 comprises one or more uplink channels and one or more downlink channels.

Space segment 110 comprises a constellation 140 of satellites in one or more orbits about the Earth. Constellation 140 comprises one or more pairs of synthetic aperture radar (SAR) and optical satellites such as 140-1, 140-2 . . . 140-N. In some implementations, a satellite may carry both SAR and optical sensors, for example a satellite that carries an L-band SAR and optical sensors. A SAR satellite is a satellite that carries one or more SAR sensors or that is dedicated to acquiring SAR data. An optical satellite is a satellite that carries one or more optical sensors or one that is dedicated to acquiring optical imagery. Each pair of satellites 140-1, 140-2 through 140-N comprises a SAR satellite 142-1, 142-2 through 142-N and an optical satellite 144-1, 144-2 through 144-N.

In one embodiment, each pair of satellites flies in a tandem configuration (one satellite leading, the other satellite trailing) and closely spaced around the orbit (for example, with a separation in time of approximately 60 seconds). In this configuration, each pair of satellites can image the same target of interest with substantially the same geometry and at substantially the same time.

In one example system, each pair of satellites 140-1, 140-2 through 140-N is in sun-synchronous orbit (SSO). In another example system, each pair of satellites 140-1, 140-2 through 140-N is in a mid-inclination orbit (MIO). In yet another example system, one or more pairs of satellites are in SSO, and one or more pairs of satellites are in MIO. More generally, each pair of satellites 140-1, 140-2 through 140-N can be in a suitable orbit about the Earth or other planetary body.

Each SAR satellite 142-1, 142-2 through 142-N illustrated in FIG. 1 comprises a SAR sensor and (optionally) a cloud camera. The SAR sensor and the cloud camera are not shown in FIG. 1. The SAR sensor acquires single-band or multi-band, and single-polarization or multi-polarization SAR data (for example, dual-polarization or quad-polarization).

Each optical satellite 144-1, 144-2, through 144-N illustrated in FIG. 1 comprises a push broom sensor operable in panchromatic and multi-spectral modes. Each optical satellite 144-1, 144-2, through 144-N illustrated in FIG. 1 further comprises a video sensor (for example, a complementary metal-oxide-semiconductor (CMOS) area array with either monochrome or RGB spectral bands).

In one mode of operation, system 100 acquires SAR and optical images of one or more targets of interest with essentially the same viewing angle and at essentially the same time (within approximately 60 seconds of each other) by cross-cueing between a SAR satellite and a corresponding optical satellite via an inter-satellite link (not shown in FIG. 1), or by uplinking one or more commands from ground segment 120 via interface 130.

In another mode of operation of system 100, for example at night or when cloud cover is obscuring a target of interest, and optical imagery cannot be acquired, system 100 acquires SAR images only via a SAR satellite (such as one of SAR satellites 142-1, 142-2, through 142-N).

Data acquired by SAR satellites 142-1, 142-2, through 142-N and optical satellites 144-1, 144-2, through 144-N may be processed on board the satellite and/or downlinked to ground segment 120 via interface 130. Ground segment 120 processes data downlinked from space segment 110 via interface 130 and/or disseminates data products to a user (not shown in FIG. 1).

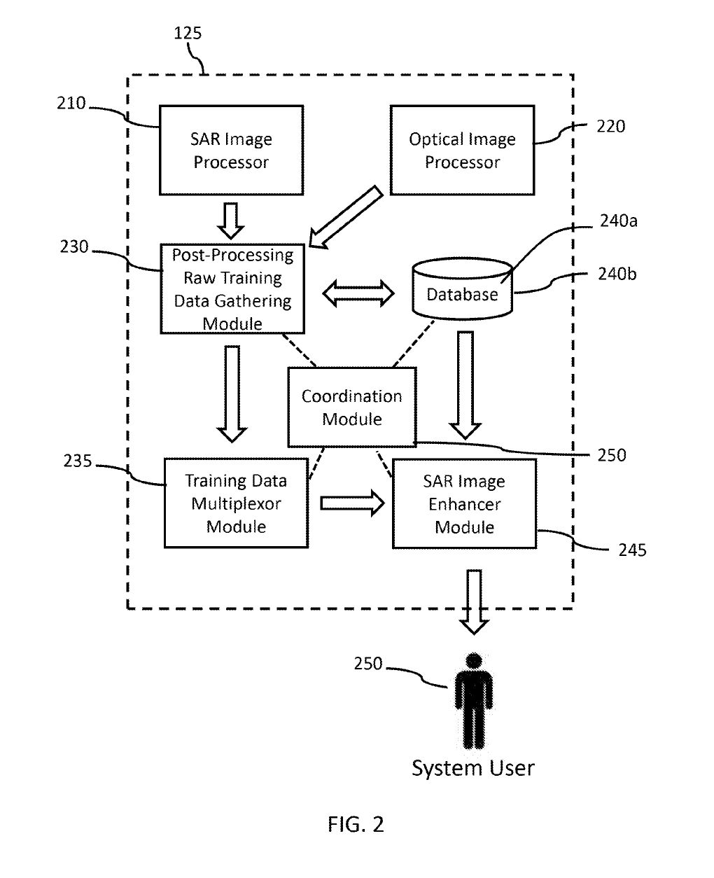

Ground segment 120 comprises data processing subsystem 125. FIG. 2 is a block diagram illustrating an embodiment of data processing subsystem 125 of FIG. 1. Data processing subsystem 125 comprises one or more SAR image processors 210, one or more optical image processors 220, a post-processing raw training data gathering set of instructions also interchangeably referred to as a post-processing raw training data gathering module 230, a training data multiplexor set of instructions, also interchangeably referred to as a training data multiplexor module 235, one or more data sets (e.g., databases) 240a that store the raw training data and multiplexed trained data implemented on one or more nontransitory computer- or processor-readable media 240b, and a SAR image enhancer set of instructions also interchangeably referred to as a SAR image enhancer module 245. Data processing subsystem 125 can be installed on one or more servers, and the elements of data processing 125 can be communicatively coupled directly or via a network.

SAR image processor 210 generates SAR imagery from raw or processed SAR data received from SAR satellites 142-1, 142-2, through 142-N of FIG. 1 via interface 130. Optical image processor 220 generates optical imagery from raw or processed optical data received from optical satellites 144-1, 144-2, through 144-N of FIG. 1.

Post-processing set of instructions or module 230 may be executable or executed by one or more processors, for example one or more microprocessors, central processor units (CPUs), graphics processor units (GPUs), application specific integrated circuits (ASICs), programmable gate arrays (PGAs), or programmable logic controllers (PLCs), which execute logic, for instance in the form of instructions stored as software or firmware instructions in one or more nontransitory computer- or processor-readable media such as memory (e.g., nonvolatile memory, volatile memory, read only memory, random access memory, flash memory, spinning magnetic or optical media, etc.

Post-processing set of instructions or module 230 ingests SAR and optical imagery from SAR image processor 210 and optical image processor 220, respectively, and, together with application-specific auxiliary data, generates application-specific classifications and associated raw training data. Intermediate data (e.g., classifications and raw training data) and imagery products can be stored in data set (e.g., database) 240a implemented on nontransitory computer- or processor-readable media 240b, keyed by each of the specific applications relevant to a scene represented by the image data or imagery.

Multiplexor set of instructions or module 235 may be executable or executed by one or more processors, for example one or more microprocessors, central processor units (CPUs), graphics processor units (GPUs), application specific integrated circuits (ASICs), programmable gate arrays (PGAs), or programmable logic controllers (PLCs), which execute logic, for instance in the form of instructions stored as software or firmware instructions in one or more nontransitory computer- or processor-readable media such as memory (e.g., nonvolatile memory, volatile memory, read only memory, random access memory, flash memory, spinning magnetic or optical media, etc.

Multiplexor set of instructions or module 235 ingests raw training data generated across multiple SAR and optical image pairs from data set (e.g., database) 240a, and, together with application-specific auxiliary data, generates application-specific SAR image enhancer parameters. By-product data (e.g., multiplexed trained data and SAR image enhancer parameters) can be stored in data set (e.g., database) 240a, keyed by each of the specific applications.

SAR image enhancer set of instructions or module 245 may be executable or executed by one or more processors, for example one or more microprocessors, central processor units (CPUs), graphics processor units (GPUs), application specific integrated circuits (ASICs), programmable gate arrays (PGAs), or programmable logic controllers (PLCs), which execute logic, for instance in the form of instructions stored as software or firmware instructions in one or more nontransitory computer- or processor-readable media such as memory (e.g., nonvolatile memory, volatile memory, read only memory, random access memory, flash memory, spinning magnetic or optical media, etc.

SAR image enhancer set of instructions or module 245 ingests SAR imagery from or generated by SAR image processor 210, and, together with application-specific auxiliary data, generates the same application-specific classifications as referred to above, that together with the multiplexed trained data and SAR image enhancer parameters, allows the SAR image enhancer set of instructions or module 245 to compute a parametric linear and non-linear combination of these classifications, and generate an enhanced SAR image. This process can be applied whenever a SAR image is acquired, and does not require an optical image to be available. When an optical image is available, it can be used to update the application-specific SAR enhancer parameters, and then the process described above can be applied to generate an enhanced image product.

Data processing subsystem 125 further comprises a coordination module 250. Coordination set of instructions or module 250 may be executable or executed by one or more processors, for example one or more microprocessors, central processor units (CPUs), graphics processor units (GPUs), application specific integrated circuits (ASICs), programmable gate arrays (PGAs), or programmable logic controllers (PLCs), which execute logic, for instance in the form of instructions stored as software or firmware instructions in one or more nontransitory computer- or processor-readable media such as memory (e.g., nonvolatile memory, volatile memory, read only memory, random access memory, flash memory, spinning magnetic or optical media, etc.

Coordination set of instructions or module 250 controls the operation and configuration of modules 230, 235, and 245, and data set (e.g., database) 240a, and coordinates the parallel processing described below. The post-processing set of instructions or module 230, multiplexor set of instructions or module 235, SAR image enhancer set of instructions or module 245, and/or coordination set of instructions or module 250 can be executed by respective processors. Such can, for example, be executed concurrently with one another via respective processors. Alternatively, two, more or all of the post-processing set of instructions or module 230, multiplexor set of instructions or module 235, SAR image enhancer set of instructions or module 245, and/or coordination set of instructions or module 250 can be executed by one processor. Such may, for example, be executed by respective cores of a multi-core processor, either concurrently with one another or sequentially. Such may, for example, be executed as respective threads of a multi-threaded processor.

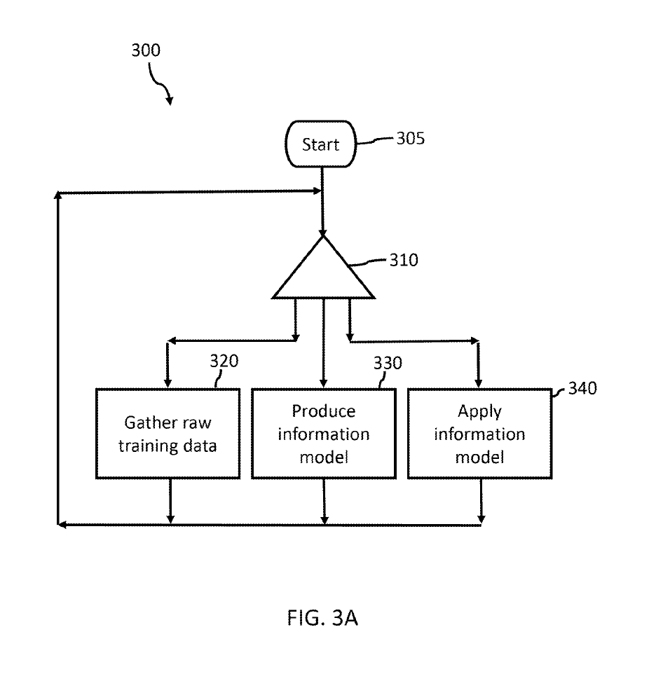

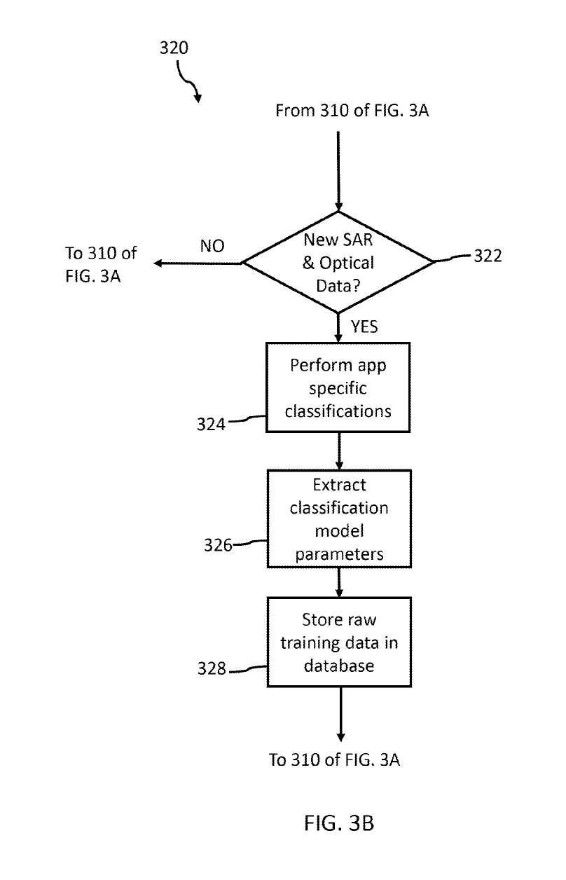

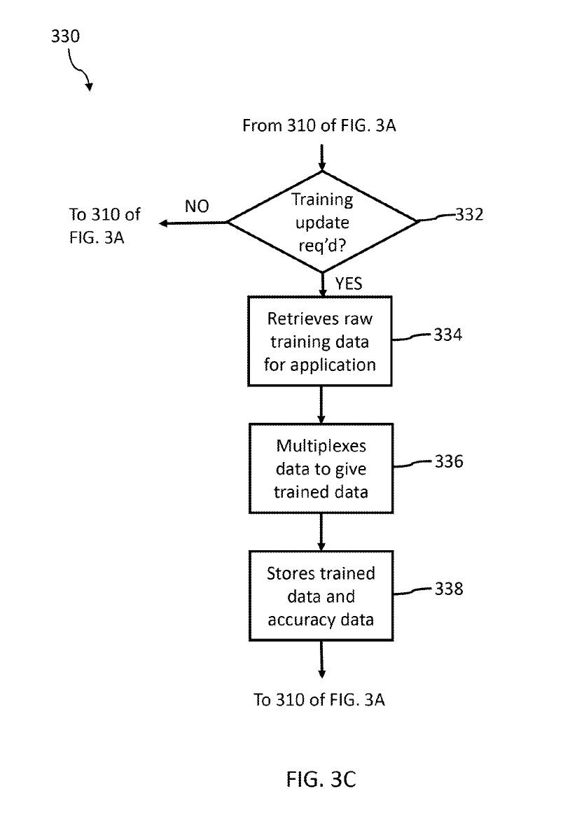

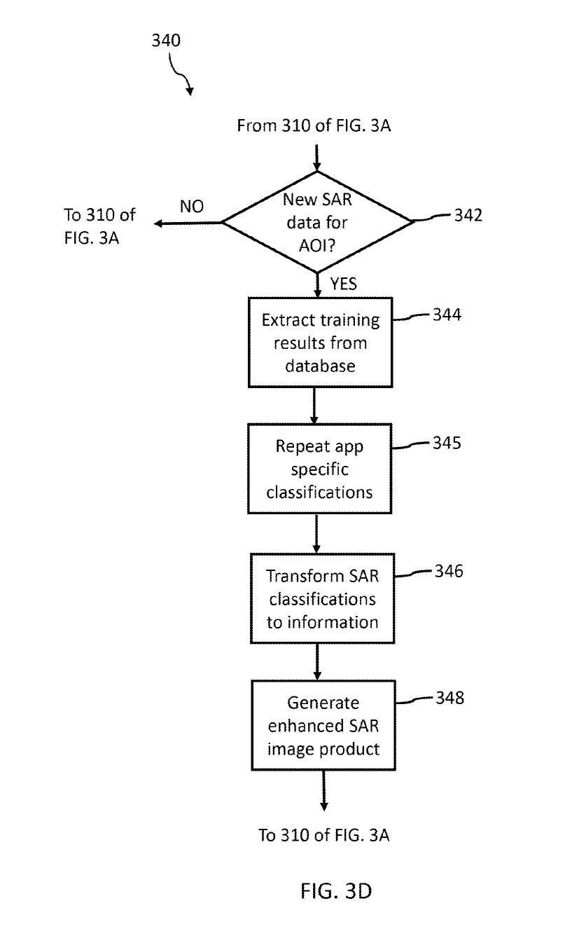

FIGS. 3A, 3B, 3C and 3D are control flow charts illustrating a method 300 for enhancing SAR imagery. Method 300 comprises three activities that can, for example, occur in parallel or concurrently, although such parallel operation may not be strictly required in some implementations.

Method 300 starts at 305 for example on a power up or on of the data processing subsystem 125, or being invoked by a calling routine or receipt of imagery data. At 310, method 300 branches into three parallel paths or routines: i) at 320, gathering raw training data in the form of a classification model as described in more detail below; ii) at 330, producing trained data in the form of an information model using the training data as described in more detail below; and iii) at 340, applying the information model to produce an enhanced SAR image, as illustrated in more detail in FIGS. 3B, 3C and 3D, respectively.

In this context, training refers to the process of establishing a repeatable, statistically meaningful relationship between observed data (such as pixels of a remotely sensed image) and “truth” data (also known as ground truth).

With reference to FIG. 3B, in one parallel path, method 300 proceeds to 322. At 322, a data processing subsystem, such as data processing subsystem 125 of FIGS. 1 and 2, determines whether there is coincident SAR and optical data, or just optical data, or just SAR data, available for the gathering of raw training data for an area of interest (AOI).

In one example implementation, data processing subsystem 125 may identify SAR and optical data as being coincident if the SAR and optical data cover a coincident geographic area, for example if the imagery data is geographically coextensive or at least partially geographically overlapping in areas represented by the SAR and optical data. In another implementation, data processing subsystem 125 may identify SAR and optical data as being coincident if the SAR and optical data were acquired at near-coincident times (for example, where data were acquired within 60 seconds of each other, or where the acquisition periods at least partially overlapped). In yet another implementation, data processing subsystem 125 may identify SAR and optical data as being coincident if the SAR and optical data cover spatially or geographically coincident geographic area and were acquired at temporally near-coincident times (e.g., within 60 seconds of one another). If the data processing subsystem 125 determines that the SAR and optical data are not coincident, then control in method 300 returns to 310 of FIG. 3A. If the data processing subsystem 125 determines that the SAR and optical data are spatially or geographically and/or temporally coincident, then control in method 300 proceeds to 324.

At 324, the data processing subsystem, performs one or more application-specific classifications of pixels in the acquired SAR and optical imagery. For example, the application-specific classification can include classification of pixels by the following optical classifications: red/green/blue (RGB) imagery, normalized differential vegetation index (NDVI) imagery, or another suitable application-specific classification that conveys information about the AOI (for example, information that may have been generated by conventional means from optical imagery alone). These application-specific classification methods can include classifications using ground truth in the case of supervised classification. Different application-specific classifications can be associated with different remotely sensed information product types provided, for example, by data processing subsystem 125 of FIGS. 1 and 2.

These classifications assume a parametric classification model. At 326, the data processing subsystem extracts the classification model parameters from the classified SAR, optical, or fused SAR and optical image data sets. For each SAR, optical, or fused SAR and optical image data set, an acquisition-dependent set of classification model parameters that constitute the raw training data are produced.

At 328, the data processing subsystem stores the raw training data associated with each SAR, optical, and fused SAR and optical classification in a data set, such as data set (e.g., database) 240a of FIG. 2. Method 300 returns to 310 of FIG. 3A.

With reference to FIG. 3C, in another parallel path, method 300 proceeds to 332. At 332, the data processing subsystem determines whether sufficient raw training data has been gathered and/or an update to the trained data is required. If not, then control in method 300 returns to 310 of FIG. 3A. If the data processing subsystem determines sufficient raw training data has been gathered and/or an update to the trained data is required, then control in method 300 proceeds to 334.

At 334, the data processing subsystem retrieves all of the available raw training data for a specific application. An example application may be “barley vigor”, “wheat yield”, or “phenological age”. Example classifiers that may be used for this example application include “NDVI”, “LAI” (Leaf Area Index) or “SMI” (Soil Moisture Index).

At 336, the data processing subsystem multiplexes the retrieved raw training data for a specific application, producing the trained data. Multiplexing is a process of applying one or more corrections and/or transformations to the data to compensate for predictable differences related to external factors, followed by aggregation or information summation.

At 338, the data processing subsystem stores the trained data, including accuracy data, in the data set, after which control in method 300 returns to 310 of FIG. 3A. The accuracy data is a measurement of the agreement between the ground truth and the processed observation data. For example, the accuracy data can be expressed using the kappa coefficient. A kappa coefficient of unity indicates perfect agreement, while a kappa coefficient of zero indicates there is absolutely no agreement. A kappa coefficient above 0.6 is considered substantial agreement, and above 0.8 is considered near perfect agreement.

With reference to FIG. 3D, in yet another parallel path, method 300 proceeds to 342. At 342, the data processing subsystem determines whether new SAR imagery over an area of interest is available for processing. If not, then control in method 300 returns to 310 of FIG. 3A. If new SAR imagery over an area of interest is available for processing, then control in method 300 proceeds to 344.

At 344, the data processing subsystem extracts previously established trained data (i.e., the classification parameters and the enhanced SAR image product parameters) from the data set, such as data set (e.g., database) 240a of FIG. 2. At 345, the data processing subsystem performs at least a subset of the same application-specific classifications of pixels in the acquired SAR imagery as previously performed. At 346, the data processing subsystem transforms the SAR classifications into the required information product (such as “barley vigor”, “wheat yield”, or “phenological age”, for example). At 348, the data processing subsystem applies the associated color palette to the SAR image and generates the corresponding metadata that provides an interpretation of the colour palette. The output from 348 is referred to as an enhanced SAR image product. Method 300 proceeds to 310 of FIG. 3A.

As described above, the data processing subsystem performs the gathering of raw training data in parallel with training using previously acquired raw training data. The data processing subsystem updates the trained data (i.e., the classification parameters and the enhanced SAR image product parameters) whenever sufficient data is available. The latest trained data is used to generate the enhanced SAR image product. For example, the trained data could be several weeks old, but the data processing subsystem can still generate an enhanced SAR image product every time a new SAR acquisition is made, and SAR acquisitions can be made daily. Coordination of data gathering, training, and image processing to produce enhanced SAR image products can be performed, for example, by coordination set of instructions or module 250 in data processing subsystem 125 of FIG. 2.

The data processing system is operable to generate enhanced SAR images when optical data is temporarily unavailable, for example when there is cloud cover. Once optical data becomes available, the data processing system can gather additional raw training data, and update the trained data. In operation, the data processing system can generate enhanced SAR image products on a continuous basis (i.e., day and night, in good and bad weather), and the classifiers and the trained data updated on a less frequent basis whenever optical data is available (e.g., during the day, and absent cloud cover).

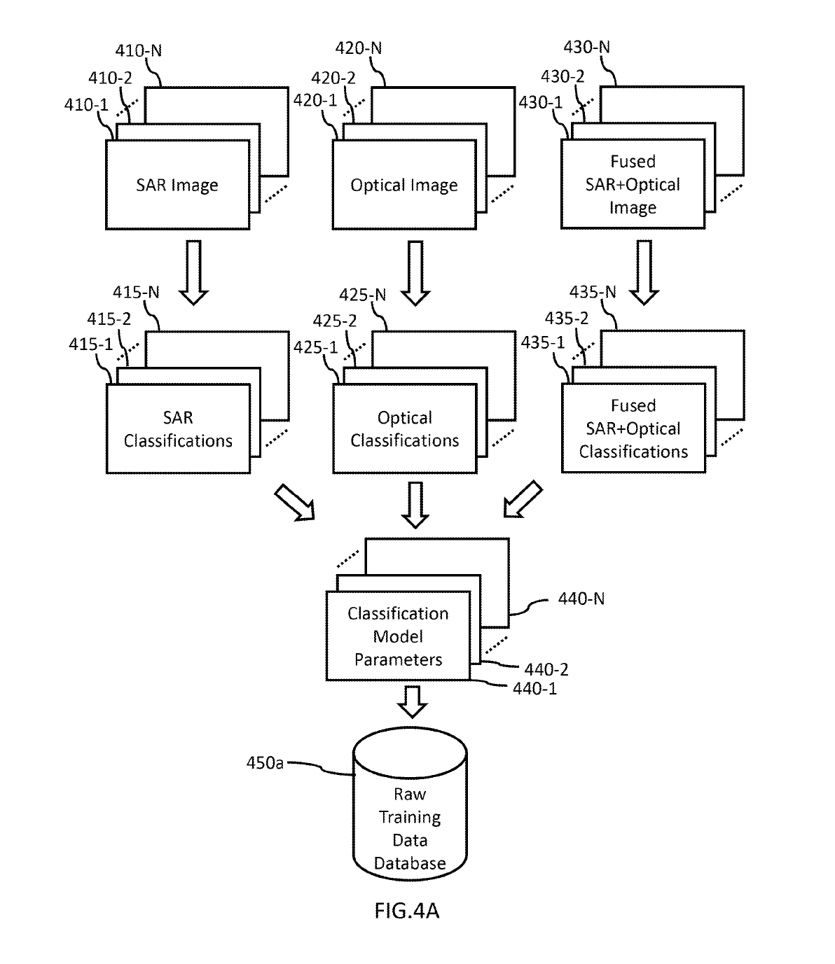

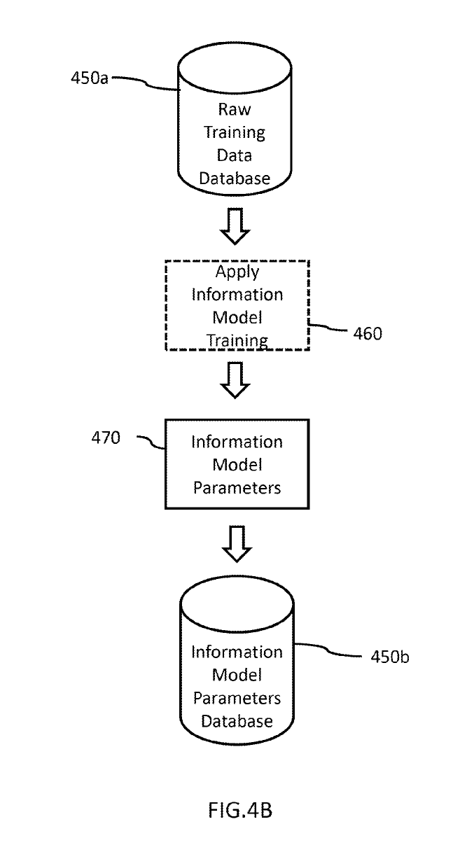

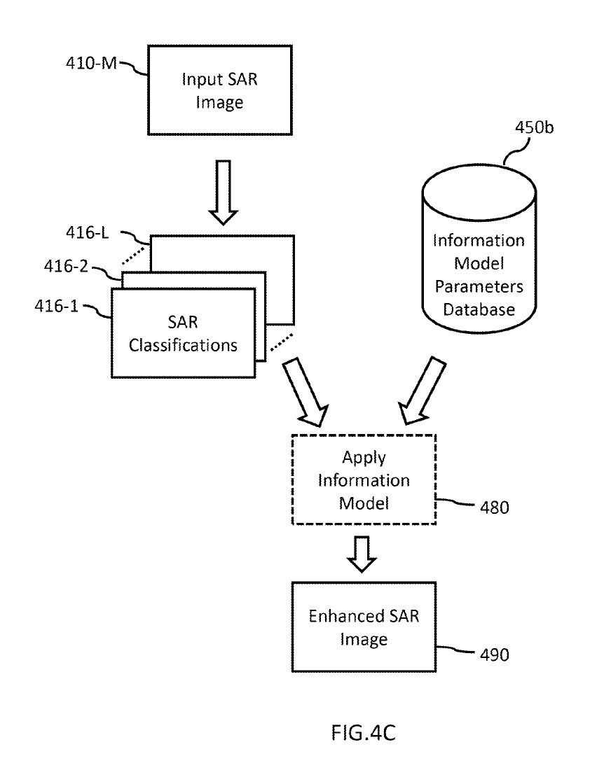

FIGS. 4A, 4B and 4C are data flow block diagrams illustrating the transformation of data for enhancing SAR imagery according to aspects of method 300 of FIG. 3A. FIG. 4A shows one or more SAR images 410-1, 410-2, through 410-N, one or more optical images 420-1, 420-2, through 420-N, and one or more fused SAR and optical images 430-1, 430-2, through 430-N. Each of the one or more SAR images 410-1, 410-2, through 410-N, one or more optical images 420-1, 420-2, through 420-N and one or more fused SAR and optical images 430-1, 430-2, through 430-N are classified to generate SAR classifications 415-1, 415-2, through 415-N, optical classifications 425-1, 425-2, through 425-N, and fused SAR and optical classifications 435-1, 435-2, through 435-N, respectively. The SAR, optical, and fused SAR and optical classifications are then used to extract classification model parameters 440-1, 440-2, through 440-N.

Both general purpose and custom applications-specific SAR image classifiers can be employed. The classification process typically comprises three acts: i) applying one or more image transformation functions to the SAR image, and the associated auxiliary data to produce an “index” image that represents information pertinent to the application; ii) thresholding the “index” image into two or more quantized bins; and iii) segmenting the image into multiple regions, where each region contains pixel values falling generally into a single quantized bin, subject to application-specific tolerances based on expected uncertainty of the values in the “index” image.

A benefit of the method described above is that it can leverage the data by taking advantage of rich information sources in the observed data which can include frequency band, backscatter intensity, phase and polarization data. For example, in the case of a dual-band SAR sensor, the relative backscatter between the two bands can provide a measure of roughness or texture in the illuminated scene, the backscatter being a function of the ratio of the roughness in the scene to the wavelength of illumination. In the case of quad-polarization SAR, the ratios between the transmitted polarization and the received polarization, for example, can provide information about the scene structure.

Both general purpose and custom applications-specific optical image classifiers can be employed. The classification process typically comprises three acts: i) applying one or more image transformation functions to the optical image, and the associated auxiliary data to produce an “index” image that represents information pertinent to the application; ii) thresholding the “index” image into two or more quantized bins; and iii) segmenting the image into multiple regions, where each region contains pixel values falling generally into a single quantized bin, subject to application-specific tolerances based on expected uncertainty of the values in the “index” image.

A benefit of the classification process described above is that the method can leverage spectral band radiance or reflectance data in the optical image.

Both general purpose and custom applications-specific fused SAR and optical image classifiers can be employed. The classification process typically comprises the following three acts: i) applying one or more image transformation functions to the fused SAR and optical image, and the associated auxiliary data to produce an “index” image that represents information pertinent to the application; ii) thresholding the “index” image into two or more quantized bins; and iii) segmenting the image into multiple regions, where each region contains pixel values falling generally into a single quantized bin, subject to application-specific tolerances based on expected uncertainty of the values in the “index” image.

A benefit of using fused SAR and optical image data is that the method can leverage the information contained in the multiple data sources.

Classifiers can be selected for a particular application. Data processing subsystem 125 of FIG. 2 can initially include and execute one or more classifiers, and can be extensible to accept and execute additional classifiers.

The classifiers can be generic classifiers, relevant to multiple applications, or the classifiers can be application-centric (or application-specific) classifiers, each performing a transformation of source data into a secondary representation. The correlation process (described in more detail below) can be used to determine the strength of each classifier in each application i.e., how effective the classifier is for each application.

There are many different classifiers for SAR imagery exploiting different types of information, e.g., intensity of backscatter, change in polarization, and dielectric properties. Polarimetric SAR data can be used as input to the classifiers. Different SAR signatures can be generated from the data and used as classifiers.

The classification model parameters are extracted from the SAR classifications 415-1, 415-2, through 415-N, optical classifications 425-1, 425-2, through 425-N, and fused SAR and optical classifications 435-1, 435-2, through 435-N. The classification model parameters are stored in data set (e.g., database) 450a. The data stored in data set (e.g., database) 450a is referred to collectively as raw training data.

FIG. 4B illustrates an example embodiment of the training process, which typically comprises an iterative process whereby parametric linear and non-linear combinations of the different SAR classifications are used to predict the optical classification(s) and generate an information model. With each iteration, the parameters are adjusted and one or more of the SAR classifications are dropped because they have little or no statistical correlation with the optical classification(s), or for which the statistical confidence in the expected spread of variance in the optical classifications is not within a defined confidence interval. The iteration completes when the remaining classifications are confirmed to have moderate to strong relationship (based on their respective kappa coefficient values, or other suitable measures) with the optical classification(s), as defined by an end user or other entity. The final set of parameters, together with a sensitivity measure for each classification, and the SAR image enhancing parameters forms the “trained data” which is then stored in data set (e.g., database) 450b for each specific application. The trained data is in the form of an information model. The information model is defined by information model parameters, and the information model parameters can be stored in an information model parameters data set such as data set (e.g., database) 450b.

Classification model parameters stored in raw training data set (e.g., database) 450a are used to generate information model parameters 470 by applying information model training at 460. Information model parameters are stored in information model parameters data set (e.g., database) 450b.

FIG. 4C shows a new SAR image 410-M and SAR classifications 416-1, 416-2, through 416-L which can be a subset of SAR classifications 415-1, 415-2, through 415-N of FIG. 4A. At 480, trained data in the form of an information model defined by the information model parameters in data set (e.g., database) 450b is applied to the SAR image 410-M and SAR classifications 416-1, 416-2, through 416-L to generate enhanced SAR image 490.

In one implementation, databases 450a and 450b can be implemented as a single data set such as data set (e.g., database) 240a of FIG. 2.

In one example implementation, the SAR image is an X-band, single polarization SAR image, and can be displayed or printed as a monochrome image. In another example implementation, the SAR image is an L-band, quad-polarization SAR image. Though the L-band quad-polarization SAR image is a single band image, it includes 4 channels of polarization data from which the scattering matrix can be derived. The polarization data can be displayed as a false color image.

In one example implementation, the optical data is a high resolution multispectral optical image. The optical image can be an RGB image, and can be displayed or printed in color.

In one example implementation of the processing of an enhanced SAR image described above, the enhanced SAR image uses an RGB application. The result can be displayed or printed as a SAR image with RGB colors reflecting the SAR classifications, and the correlations between the SAR classifications and in the trained data retrieved from a data set, such as data set (e.g., database) 450a of FIG. 4A.

Each enhanced SAR image can employ a color scheme selected to convey the information in the image in an effective fashion. In one example, the color scheme can be selected to provide an “optical-like” appearance to ease interpretation of the image. Other examples can have different color schemes, and may not mimic the appearance of an optical image.

Enhanced information product types can be tailored to suit particular applications, and to provide information rich in content that can be more readily interpreted by non-experts. There is a wide range of possible applications of the technology including, but not limited to, agriculture, forestry monitoring, surveillance including maritime surveillance, and the like, data analytics using Earth observation data, and consumer/social media-based applications.

The above description of illustrated embodiments, including what is described in the Abstract, is not intended to be exhaustive or to limit the various embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other imaging systems, not necessarily the exemplary satellite imaging systems generally described above.

While the foregoing description refers, for the most part, to satellite platforms for SAR and optical sensors, remotely sensed imagery can be acquired using airborne sensors including, but not limited to, aircraft and drones. The technology described in this disclosure can be applied to imagery acquired from sensors on spaceborne and airborne platforms.

The various embodiments described above can be combined to provide further embodiments. U.S. Provisional Patent Application Ser. No. 62/137,934, filed Mar. 25, 2015 (Atty. Docket No. 920140.404P1); U.S. Provisional Patent Application Ser. No. 62/180,421, filed Jun. 16, 2015 and entitled “EFFICIENT PLANAR PHASED ARRAY ANTENNA ASSEMBLY” (Atty. Docket No. 920140.405P1); U.S. Provisional Patent Application Ser. No. 62/180,440, filed Jun. 16, 2015 and entitled “SYSTEMS AND METHODS FOR REMOTE SENSING OF THE EARTH FROM SPACE” (Atty. Docket No. 920140.406P1); and U.S. Provisional Patent Application Ser. No. 62/180,449, filed Jun. 16, 2015 and entitled “SYSTEMS AND METHODS FOR ENHANCING SYNTHETIC APERTURE RADAR IMAGERY” (Atty. Docket No. 920140.407P1), are each incorporated herein by reference, in their entirety. Aspects of the embodiments can be modified, if necessary, to employ systems, circuits and concepts of the various patents, applications and publications to provide yet further embodiments.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

These and other changes can be made in light of the above-detailed description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure.

1. A method of operation of a synthetic aperture radar (SAR) image processing system, the method comprising:
a. gathering a set of raw training data, the gathering comprising:
receiving a training SAR image and a training optical image;
determining one or more classifiers for a selected application;
applying the one or more classifiers to the training SAR image and the training optical image to generate one or more classifications;
determining one or more correlations between the one or more classifications;
extracting classification model parameters based on the one or more correlations; and
storing a set of raw training data comprising the classification model parameters in a first data set;
b. generating an information model comprising a set of information model parameters, the information model defining a set of trained data, the generating an information model comprising:
retrieving the set of raw training data from the first database;
multiplexing the set of raw training data to generate the information model; and
storing the information model parameters in a second data set; and
c. processing an input SAR image, the processing comprising:
receiving the input SAR image;
extracting at least a subset of the information model parameters from the second data set;
applying one or more SAR classifiers to the input SAR image to generate one or more SAR classifications; and
applying the information model to the one or more SAR classifications to generate an enhanced SAR image.

2. The method of claim 1, further comprising applying a color palette to the enhanced SAR image, wherein the color palette conveys information for the selected application based at least in part on the information model.

3. The method of claim 1 wherein receiving a training SAR image and a training optical image includes receiving a training SAR image and a training optical image that are geographically coincident.

4. The method of claim 1 wherein receiving a training SAR image and a training optical image includes receiving a training SAR image and a training optical image that are temporally coincident or near-coincident.

5. The method of claim 1 wherein receiving a training SAR image and a training optical image includes receiving a training SAR image and a training optical image that are geographically coincident, and receiving a training SAR image and a training optical image that are temporally coincident or near-coincident.

6. The method of claim 1 wherein two or more of the gathering a set of raw training data, the generating an information model, and the processing an input SAR image are performed concurrently.

7. The method of claim 1 wherein determining one or more classifiers for a selected application includes determining a first classifier for the training SAR image and determining a second classifier for the training optical image, and applying the one or more classifiers to the training SAR image and the training optical image to generate one or more classifications includes applying the first classifier to the training SAR image and applying the second classifier to the training optical image.

8. The method of claim 1 wherein the gathering, and/or the generating, are repeated iteratively for a plurality of instances, and in each iteration, adjusting one or more parameters and dropping one or more of the SAR classifications based on a level of statistical correlation with the optical classifications, or for which the statistical confidence in the expected spread of variance in the optical classifications is not within a defined confidence interval.

9. The method of claim 8, further comprising:
confirming that any remaining classifications have a moderate to a strong relationship based on a respective kappa coefficient value with the optical classifications; and
in response to confirmation, stopping the iteration.

10. A synthetic aperture radar (SAR) image processing system comprising:
at least one nontransitory computer-readable medium that stores processor-executable instructions and data, the at least one nontransitory computer-readable medium which stores:
a first data set of raw training data comprising classification model parameters based at least in part on a training SAR image and a training optical image, and that stores a second data set of trained data comprising an information model defined by information model parameters;
a set of data gathering instructions which, when executed by at least one processor, cause the at least one processor to i) receive the training SAR image and the training optical image; ii) determine one or more classifiers for a selected application; and iii) apply the one or more classifiers to the training SAR image and the training optical image to generate the classification model parameters, the data gathering module communicatively coupled to the first data set to store the classification model parameters therein;
a set of training instructions which, when executed by at least one processor, cause the at least one processor to receive the classification model parameters from the first data set, generate trained data comprising an information model, and store the information model parameters to the second data set; and
a set of SAR image enhancer instructions which, when executed by at least one processor, cause the at least one processor to receive SAR image data from a source of SAR image data, classify the SAR image data, and apply the information model to generate an enhanced SAR image product.

11. The SAR image processing system of claim 10, further comprising:
a set of display instructions which, when executed by the at least one processor, cause the at least one processor to manifest the enhanced SAR image product as a coloring of the SAR image wherein the coloring comprises a color palette that conveys information for the selected application based at least in part on the information model.

12. The SAR image processing system of claim 10 wherein the training SAR image and the training optical image are geographically coincident.

13. The SAR image processing system of claim 10 wherein the training SAR image and the training optical image are temporally coincident or near-coincident.

14. The SAR image processing system of claim 10 wherein the training SAR image and the training optical image are geographically coincident, and the training SAR image and the training optical image are temporally coincident or near-coincident.

15. The SAR image processing system of claim 10 wherein the set of data gathering instructions, the set of training instructions, and the set of SAR image enhancer instructions operate concurrently.

16. The SAR image processing system of claim 10 wherein the set of data gathering instructions, the set of training instructions, and the set of SAR image enhancer instructions operate concurrently on respective processors.

17. The SAR image processing system of claim 10 wherein the set of data gathering instructions, the set of training instructions, and the set of SAR image enhancer instructions operate concurrently on respective cores of a single processor.

18. The SAR image processing system of claim 10 wherein the one or more classifiers for the selected application comprise a first classifier for the training SAR image and a second classifier for the training optical image.

19. The SAR image processing system of claim 10 wherein the at least one processor iteratively executes the set of data gathering instructions, and/or the set of training instructions for a plurality of instances, and in each iteration, adjusts one or more parameters and drops one or more of the SAR classifications based on a level of statistical correlation with the optical classifications or for which the statistical confidence in the expected spread of variance in the optical classifications is not within a defined confidence interval.

20. The SAR image processing system of claim 19 wherein the instructions, when executed, cause at least one processor further to:
confirm that any remaining classifications have a moderate to a strong relationship based on a respective kappa coefficient value with the optical classifications; and
in response to confirmation, stop the iteration.

21. The method of claim 2 wherein receiving a training SAR image and a training optical image includes receiving a training SAR image and a training optical image that are at least one of geographically coincident and temporally coincident or near-coincident.

22. The method of claim 2 wherein two or more of the gathering a set of raw training data, the generating an information model, and the processing an input SAR image are performed concurrently.

23. The method of claim 2 wherein determining one or more classifiers for a selected application includes determining a first classifier for the training SAR image and determining a second classifier for the training optical image, and applying the one or more classifiers to the training SAR image and the training optical image to generate one or more classifications includes applying the first classifier to the training SAR image and applying the second classifier to the training optical image.

24. The method of claim 2 wherein the gathering, and/or the generating, are repeated iteratively for a plurality of instances, and in each iteration, adjusting one or more parameters and dropping one or more of the SAR classifications based on a level of statistical correlation with the optical classifications, or for which the statistical confidence in the expected spread of variance in the optical classifications is not within a defined confidence interval.

25. The SAR image processing system of claim 11 wherein the training SAR image and the training optical image are at least one of geographically coincident and temporally coincident or near-coincident.

26. The SAR image processing system of claim 11 wherein the set of data gathering instructions, the set of training instructions, and the set of SAR image enhancer instructions operate concurrently.

27. The SAR image processing system of claim 11 wherein the one or more classifiers for the selected application comprise a first classifier for the training SAR image and a second classifier for the training optical image.

28. The SAR image processing system of claim 11 wherein the at least one processor iteratively executes the set of data gathering instructions, and/or the set of training instructions for a plurality of instances, and in each iteration, adjusts one or more parameters and drops one or more of the SAR classifications based on a level of statistical correlation with the optical classifications or for which the statistical confidence in the expected spread of variance in the optical classifications is not within a defined confidence interval.
